(19) United States
(12) Patent Application Publication
(10) Pub. No.: US 2012/0098291 A1
(43) Pub. Date: Apr. 26, 2012

(54) FOLD DOWN SAFETY SUN GUARD SYSTEMS

(76) Inventor: Robert L. Wilson, Hamilton, TX (US)

(21) Appl. No.: 13/278,889

(22) Filed: Oct. 21, 2011

Related U.S. Application Data
(60) Provisional application No. 61/406,482, filed on Oct. 25, 2010.

(51) Int. Cl. B60J 3/02

(52) U.S. Cl. 296/97.12

(57) ABSTRACT

A vehicle side window safety sun guard system for shielding a driver-user's eyes and face from bright sunlight entering a vehicle cab through a side window. The sun visor may be in addition to the standard front mounted sun visor and is mounted to the framework above the driver's and/or passenger's door side window of a truck and covers the entire length of the upper portion of the side window. The visor may be constructed of an opaque material or may be semi-transparent. The visor system may comprise a mounting flange, a pivot arm, a sun visor, and a proximate end sun shield support bracket.

### CROSS-REFERENCE TO RELATED APPLICATION

The present application is related to and claims priority from prior provisional application Ser. No. 61/406,482, filed Oct. 25, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of sun visors and more specifically relates to extended length vehicle side window sun visors.

2. Description of the Related Art

The majority of modern vehicles intended for use on public roads are equipped with front-mounted sun visors. A sun visor is a component of an automobile located on the interior just above the windshield also known as a windscreen. Sun visors keep the suds glare out of vehicle drivers' eyes and help keep passengers cool. Most cars have two sun visors, one for the driver's side and a second for the passenger's side, with the rear-view minor often mounted in between the two sun visors. Each visor can be ‘lowered’ to help block light from entering through the windshield where the bright light potentially poses a safety problem when the vehicle is in motion.

A sun visor is normally completely opaque and when manually rotated downward from the stowed position, can block the unwanted sun and glare. When used properly, sun visors can add comfort and safety while traveling. In early morning and on late afternoon drives, the sun can wreak havoc on a driver's vision despite the gradient tint on the upper portion of most windshields. Most sun visors are designed so they can be turned to the vehicle side window to reduce lateral sun exposure also. When sun visors are turned to cover a vehicle side window, usually only the mid to front portion of the side window is covered. This is because sun visors are shortened to leave space for the vehicle rearview mirror when the visor is placed in the stowed or front windshield position. Sunlight entering a driver's side window just past the sun visor's reach can be very annoying. When sunlight enters the vehicle cab between the sun visors while they are placed in the front windshield position, it is a nuisance for drivers as well, and has been attributed to many accidents.

Exterior sun visors are available for trucks as cab visors but they have limited ability to block the sun, being effective only when the sun is at a higher angle. The design of most sun visors that allows them to swivel from the front windshield to the side window provides added functionality for the driver but has some limitations. When the sun enters the cab at an angle between the front windshield and the side window, slight changes in road direction cause the driver to be distracted while continuously swiveling the visor from front to side to block the bright light. A visor that would be long enough to cover the entire upper portion of a side window would be too long to fit in the windshield without interfering with the rearview mirror. A better solution is needed.

Various attempts have been made to solve the above-mentioned problems such as those found in U.S. Pat. Nos. 5,390,973; 5,445,427; 5,575,522; 4,792,177; 4,023,856; and 5,673,957. This prior art is representative of sun visors. None of the above inventions and patents, taken either singly or in combination, is seen to describe the invention as claimed.

Ideally, a side window sun visor should be of sufficient length to completely cover a side window upper portion of a semi-truck and yet, would not be cumbersome in operation, thus operate reliably and be manufactured at a modest expense. Thus, a need exists for a reliable fold down safety sun guard system to shield a driver's eyes from sunlight coming into a truck cab from a side window, and to avoid the above-mentioned problems.

### BRIEF SUMMARY OF THE INVENTION

In view of the foregoing disadvantages inherent in the known sun visor art, the present invention provides a novel vehicle safety sun guard system. The general purpose of the present invention, which will be described subsequently in greater detail, is to provide an adjustable position sun visor for use in the driver's side door window to prevent glare from affecting the driver's vision.

The vehicle side window safety sun guard system may comprise at least one mounting flange, at least one pivot arm, and at least one sun visor. The pivot arm preferably comprises a first portion having a proximate and a distal end and a pivot arm second portion having a proximate and a distal end, and a sunshield (sun-shielding means.) The mounting flange may comprise a plurality of orifices for accepting fasteners and is preferably removably fastened above a vehicle driver's side door to an interior door framework. In most embodiments, the mounting flange comprises steel but may comprise a non-ferrous metal or non-metal in alternate embodiments.

The mounting flange may be substantially flat and have a triangular shape (profile), a circular shape, or a shape comprising four (or more) perimeter edges to conform to various contours of different makes and models of vehicles. The pivot arm first portion may comprise about a 90 degree bend wherein the distal end of the pivot arm first portion is coupled to the mounting flange such that the pivot arm first portion is horizontally rotatable. The pivot arm first portion may have a greater than 90 degree bend or less than a 90 degree bend as needed to allow the pivot arm to adjust horizontally to a user desired position. The pivot arm first portion preferably comprises a ferrous metal but in some embodiments may be a non-ferrous metal or a non-metal and the pivot arm second portion may comprise a straight shaft having a proximate and a distal end, coupled at the proximate end to the pivot arm first portion such that the pivot arm second portion is vertically rotatable. The vehicle side window safety sun guard system further may comprise a pivot arm second portion support bracket for revolvably and rotationally coupling the proximate end of the pivot arm second portion. The pivot arm second portion may comprise a ferrous metal but may be a light-weight non-ferrous metal or plastic.

The visor may comprise a cutout portion at the proximate end of the pivot arm second portion exposing a small portion of the pivot arm second portion wherein it may be removably connected to the pivot arm second portion support bracket. The pivot arm second portion vertical rotation movement is frictionally constricted within the pivot arm first portion such that the safety sun guard is able to remain in a user-preferred position for an extended duration. The sunshield is substantially flat having a first side and a second side and a proximate edge and a distal edge and wherein the distal edge preferably has a greater thickness than the proximate edge and wherein the distal edge of the sunshield is non-removably attached to the pivot arm second portion such that the distal end of the sunshield envelopes the pivot arm second portion and is usable as a sun-visor that is movable. The visor non-rotatably envelopes the pivot arm second portion and may comprise a sunlight blocking material that is opaque, or in some embodiments may comprise a partial sunlight blocking material that is semi-transparent. The sunshield is preferably sufficiently long so as to cover a side window upper portion's entire width and is thus useable as a sun-blocker to create greater visibility and safety for a driver-user when sunlight enters a driver's door side window of a vehicle. In this way the present invention serves to entirely block the top of the driver's side window from sun entering as glare and thus promotes safety in use. The visor as discussed herein is side positioned and located in the vehicle in addition to a front-mounted-visor. The sun-blocker device may also be mounted further rearwardly in relation to the back of the cab to achieve this.

A further embodiment of the present invention may comprise a hinged semi-transparent lens-visor that may be attached to the sun-blocker device. This version may be connected to the sun-blocker device and rotated about an axis down into position to further block sun glare. This hinged semi-transparent lens-visor in combination with the sun-blocker device creates an increased area of sun blockage and partial blockage. The hinged semi-transparent lens-visor may be rotated upwardly to a non-use position during non-use periods. Other embodiments may comprise telescoping means (slides in and out of sun-blocker device) and/or other equivalent means as an alternative to rotating means.

The vehicle side window safety sun guard system may comprise a kit having at least one sunshield with fasteners and the mounting flange(s), and a set of user instructions.

A method of use for a vehicle side window safety sun guard system may comprise the steps of: gripping the proximate edge of the visor located above a side window on the vehicle and adjusting the visor horizontally and/or vertically to a user preferred position for blocking sunlight from interfering with the driver-user's vision.

The present invention holds significant improvements and serves as a fold down safety sun guard system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, fold down safety sun guard systems, constructed and operative according to the teachings of the present invention.

FIG. 1 shows a perspective view illustrating a vehicle side window safety sun guard system in an in-use condition according to an embodiment of the present invention.

FIG. 2 is a perspective view illustrating the vehicle side window safety sun guard system in a non-use condition according to an embodiment of the present invention of FIG. 1.

FIG. 3 is a perspective view illustrating the vehicle side window safety sun guard system mounting flange, pivot arm, and optional pivot arm second portion support bracket according to an embodiment of the present invention of FIGS. 1 and 2.

FIG. 4 is a flowchart illustrating a method of use for a vehicle side window safety sun guard system according to an embodiment of the present invention of FIGS. 1-3.

The various embodiments of the present invention will hereinafter be described in conjunction with the appended drawings, wherein like designations denote like elements.

### DETAILED DESCRIPTION

As discussed above, embodiments of the present invention relate to a vehicle sun visor device and more particularly to a fold down safety sun guard system mounted adjacent a driver's side window as used to improve a driver-user's comfort and safety by reducing glare.

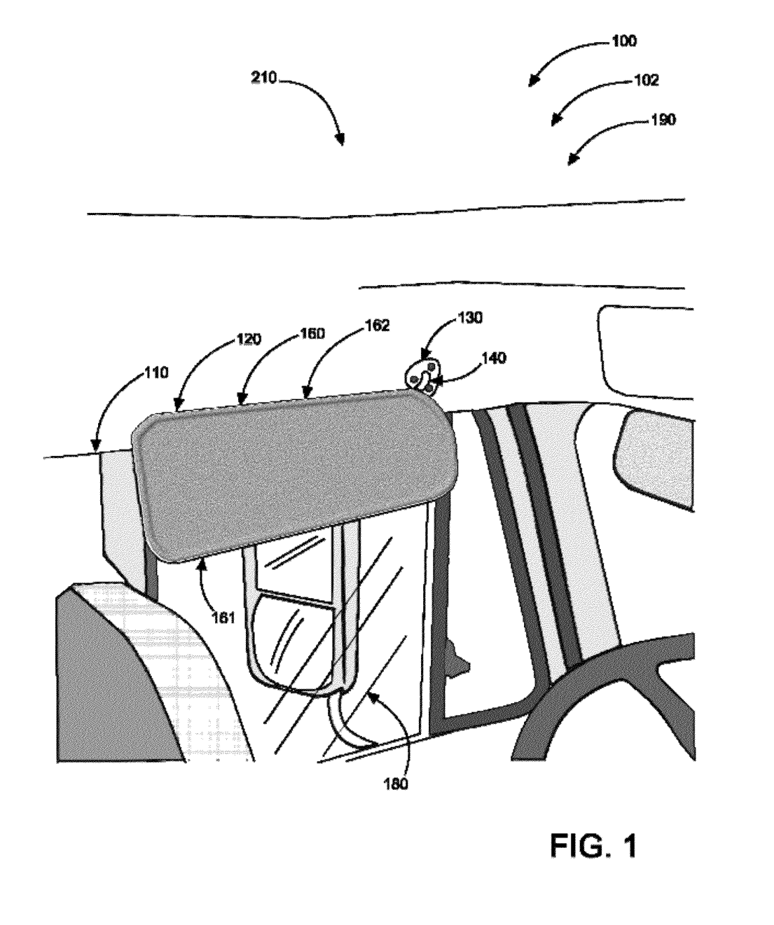

Referring now to the drawings by numerals of reference there is shown in FIG. 1, a perspective view illustrating vehicle side window safety sun guard system 102 in an in-use condition 190 according to an embodiment of the present invention. Generally speaking, fold down safety sun guard systems 100 is designed to protect drivers of (large commercial tractors) trucks (and other other equipment such as graders, tractors, smaller vehicles and the like) from blinding sunlight that enters side window 180 during driving periods. This device is preferably mounted to the interior door framework 110 above and adjacent the driver's side door inside a commercial truck and is utilized, as mentioned, to block harsh glare from the sun across the entire length of side window 180. The device can be pivoted up and down as necessary according to the position of the sun, and may be designed to cover the gap (additional distance/area) that conventional front-mount sun visors cannot obstruct. Therefore, using vehicle side window safety sun guard system 102 may increase a driver-user's comfort and safety while traveling.

Vehicle side window safety sun guard system 102 may comprise mounting flange 130, pivot arm 140 that may comprise two parts: pivot arm first portion 142 having a proximate end 143 and distal end 144; and pivot arm second portion 145 having proximate end 146 and distal end 147; and sunshield 160 also having proximate end 161 and distal end 162. Mounting flange 130 is removably fastened above a vehicle driver's side door to interior door framework 110 and distal end 144 of pivot arm first portion 142 is rotatably coupled to mounting flange 130 comprising an approximate 90 degree bend such that pivot arm first portion 142 is horizontally rotatable. Pivot arm second portion 145 may be comprised of straight shaft 170 having proximate end 171 and distal end 172 and is coupled to proximate end 143 of pivot arm first portion 142 such that pivot arm second portion 145 is vertically rotatable. Sunshield 160 is substantially flat having a first side and a second side and proximate edge 161 and distal edge 162 and wherein distal edge 162 may have a greater thickness than proximate edge 161 and wherein distal edge 162 of sunshield 160 is non-removably attached to pivot arm second portion 145 such that distal edge 162 of sunshield 160 envelopes pivot arm second portion 145. Sunshield 160 is sufficiently long enough to cover side window 180 upper portion width such that sunshield 160 is useable as a sun-blocker to create greater visibility and safety for a driver-user when sunlight enters driver's door side window 180 of a vehicle. The present invention is approximately 20″-30″ long (may be longer or shorter as per application and vehicle type) and may telescope in certain embodiments to accommodate various sizes of OEM side windows 180 from various trucks and vehicles. Other downward extensions may be available to further decrease sun glare. In certain embodiments sun visor 120 may extend beyond side window 180 overlapping rearwardly.

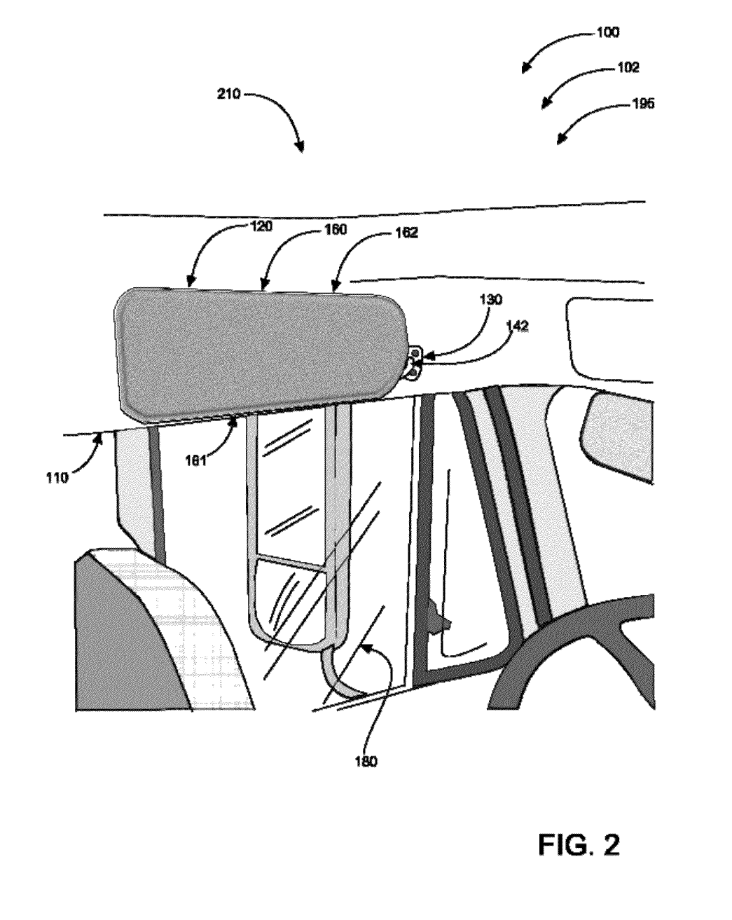

Referring now to FIG. 2, a perspective view illustrating vehicle side window safety sun guard system 102 in a non-use condition 195 (folded up position) according to an embodiment of the present invention of FIG. 1. Sunshield 160 comprises sun visor 120 that is movable and/or tiltable by a user. Pivot arm second portion 145 is rotatably coupled to pivot arm first portion 142 such that vertical rotation movement of pivot arm second portion 145 is frictionally constricted within pivot arm first portion 142 so that sunshield 160 is able to remain in a user-preferred position for an extended duration in a static/stationary condition. Sun visor 120 non-rotatably envelopes pivot arm second portion 145 and rotates vertically with pivot arm second portion 145 to in-use condition 190 or to non-use condition 195. Sun visor 120 may, in some embodiments, comprise optional cutout portion 220 such that proximate end 146 of pivot arm second portion 145 is exposed for removably connecting to pivot arm second portion support bracket 200. Sun visor 120 preferably comprises a sunlight blocking material that is opaque but in some embodiments may comprise a partial sunlight blocking material that is semi-transparent (such as tinted plastic or the like.) Semi-transparent embodiments may comprise various degrees of transparency to allow different amounts/degrees of light in, if desired.

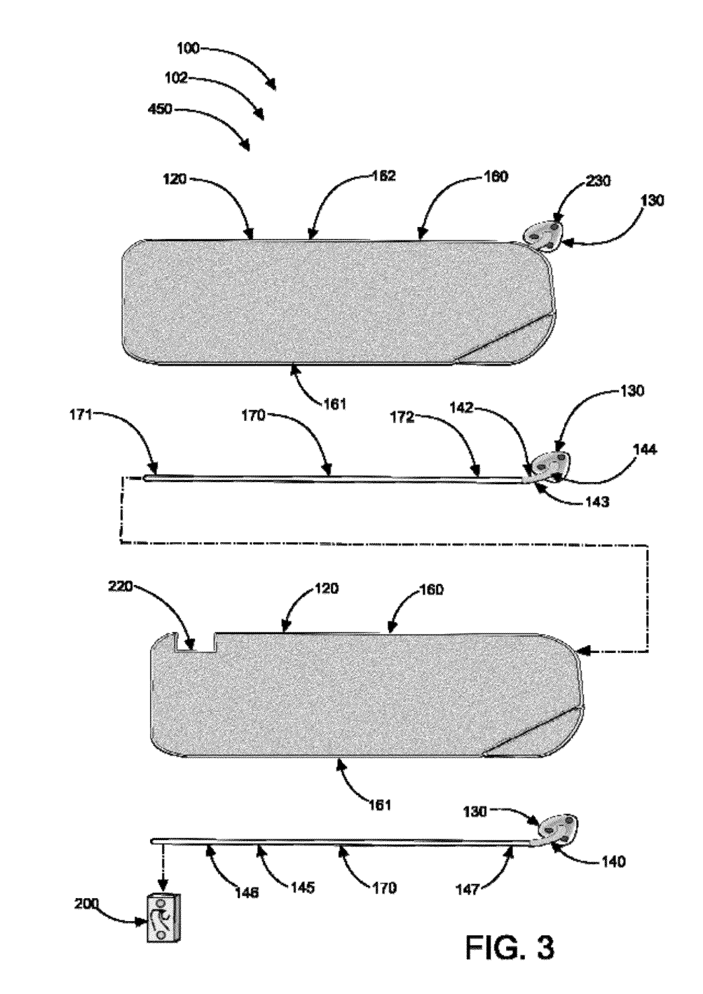

Referring now to FIG. 3, a perspective view illustrating vehicle side window safety sun guard system 102 mounting flange 130, pivot arm 140, and pivot arm second portion support bracket 200 according to an embodiment of the present invention of FIG. 1. Fold down safety sun guard systems 100 provides commercial truck drivers with an effective tool for blocking sunlight while driving, as previously mentioned and illustrated. The invention may comprise a substantially rectangular sunshield 160 made of opaque or transparent material, such as vinyl, plastic, paper board, or other suitable material. It may be attached to vehicle cab 210 interior door framework 110 via mounting flange 130 and removably attached with suitable fasteners such as screws (or equivalent fastening means.) After installation in vehicle cab 210, the device may frictionally (yet freely) pivot up and down to block shifting sunlight. The exact specifications may vary according to various embodiments.

Mounting flange 130 preferably comprises a plurality of orifices 230 for accepting/receiving fasteners such that mounting flange 130 is removably attached to interior door framework 110 above a vehicle driver's side door. Mounting flange 130 preferably may be constructed of steel but may be constructed of a non-ferrous metal or a rigid non-metal material and be circular, triangular, or may be rectangular having four perimeter edges of varying dimensions as may be needed to fit (with) various interior door frameworks 110. Pivot arm first portion 142 may comprise a greater than 90 degree bend or may comprise a less than 90 degree bend as needed to provide a horizontal travel pattern when pivot arm first portion 142 is horizontally rotated. In some embodiments, pivot arm first portion 142 may not swivel horizontally but may be dedicated for use for side window 180 only. Pivot arm first portion 142 preferably comprises a ferrous metal but may comprise a non-ferrous metal or other suitable equivalent non-metal rigid material that is durable in-use. Pivot arm second portion 145 may comprise a ferrous metal but may comprise a non-ferrous metal or a non-metal rigid material such as plastic. In some embodiments, sun visor 120 and pivot arm second portion 145 may have pivot arm second portion support bracket 200 for revolvably and rotationally coupling proximate end 146 of pivot arm second portion 145.

Vehicle side window safety sun guard system 100, according to an embodiment of the present invention of FIGS. 1-3 may be sold as kit 450 comprising the following parts: at least one sunshield 160; at least one fastener; and at least one mounting flange 130; with a set of user instructions. Vehicle side window safety sun guard system 100 may be manufactured and provided for sale in a wide variety of sizes and shapes for a wide assortment of vehicle and machine applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different length/widths, parts may be sold separately, etc., may be sufficient.

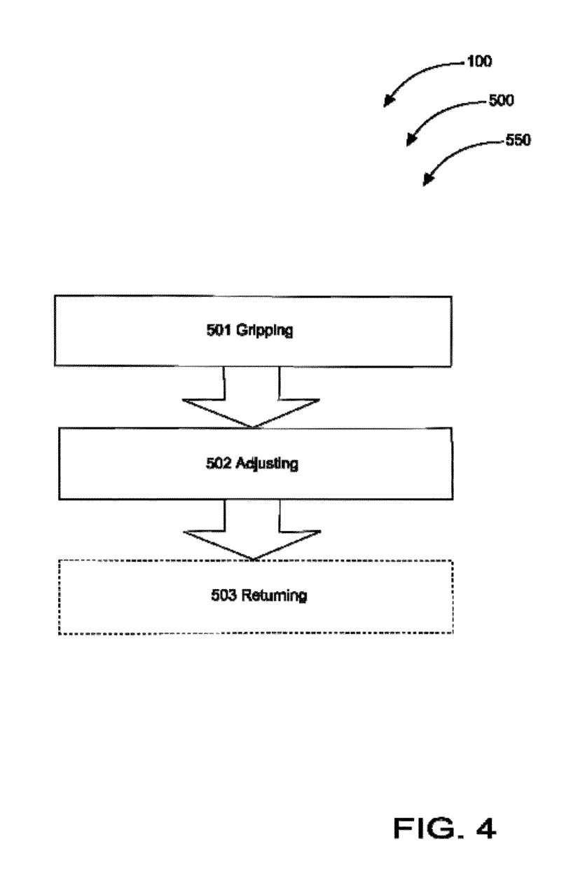

Referring now to FIG. 4, a flow chart 550 illustrating method of use 500 for vehicle side window safety sun guard system 102 comprising the steps of: step one 501 gripping proximate edge 161 of sun visor 120 located above side window 180 on a vehicle; step two 502 adjusting sun visor 120 horizontally and/or vertically to a user-preferred position for blocking sunlight from interfering with a driver-user's vision (across the entire length of side window 180, and step three 503 returning sun visor 120 to an upward folded non-use condition 195 above side window 180.

It should be noted that step 503 is an optional step and may not be implemented in all cases. Optional steps of method 500 are illustrated using dotted lines in FIG. 4 so as to distinguish them from the other steps of method 500.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended

1. A vehicle side window safety sun guard system comprising:
a mounting flange;
a pivot arm comprising:
a pivot arm first portion having a proximate and a distal end; and
a pivot arm second portion having a proximate and a distal end; and
a sunshield;
wherein said mounting flange is removably fastened above and adjacent a vehicle driver's side door to an interior door framework;
wherein said pivot arm first portion comprises a 90 degree bend and wherein said distal end of said pivot arm first portion is coupled to said mounting flange such that said pivot arm first portion is horizontally rotatable;
wherein said pivot arm second portion comprises a straight shaft having a proximate and a distal end and is coupled to said proximate end of said pivot arm first portion such that said pivot arm second portion is vertically rotatable;
wherein said sunshield is substantially flat having a first side and a second side and a proximate edge and a distal edge and wherein said distal edge has a greater thickness than said proximate edge and wherein said distal edge of said sunshield
is non-removably attached to said pivot arm second portion such that said distal end of said sunshield envelopes said pivot arm second portion; and
wherein said sunshield is about 26 inches long, sufficient to at least cover an entire width of an upper portion of said side window such that said sunshield is useable as a sun-blocker to create greater visibility and safety for a user when sunlight enters driver's door said side window of said vehicle.

2. The vehicle side window safety sun guard system of claim 1 wherein said mounting flange comprises a plurality of orifices for accepting fasteners such that said mounting flange is removably attachable to said interior door framework above and adjacent said vehicle driver's side door.

3. The vehicle side window safety sun guard system of claim 2 wherein said mounting flange comprises steel.

4. The vehicle side window safety sun guard system of claim 2 wherein said mounting flange is triangular.

5. The vehicle side window safety sun guard system of claim 2 wherein said mounting flange is circular.

6. The vehicle side window safety sun guard system of claim 2 wherein said mounting flange comprises at least four perimeter edges.

7. The vehicle side window safety sun guard system of claim 1 wherein said pivot arm first portion comprises a greater than 90 degree bend.

8. The vehicle side window safety sun guard system of claim 1 wherein said pivot arm first portion comprises a less than 90 degree bend.

9. The vehicle side window safety sun guard system of claim 1 wherein said pivot arm first portion comprises a ferrous metal.

10. The vehicle side window safety sun guard system of claim 1 wherein said pivot arm second portion comprises a ferrous metal.

11. The vehicle side window safety sun guard system of claim 10 wherein said pivot arm second portion vertical rotation movement is frictionally constricted within said pivot arm first portion such that said safety sun guard is able to remain stationary in a user-preferred position for an extended duration.

12. The vehicle side window safety sun guard system of claim 1 wherein said sunshield comprises a visor that is movable and tiltable.

13. The vehicle side window safety sun guard system of claim 12 wherein said visor non-rotatably envelopes said pivot arm second portion.

14. The vehicle side window safety sun guard system of claim 1 further comprising a pivot arm second portion support bracket for revolvably and rotationally coupling said proximate end of said pivot arm second portion.

15. The vehicle side window safety sun guard system of claim 12 wherein said visor comprises a cutout portion such that said proximate end of said pivot arm second portion is exposed for removably connecting to said pivot arm second portion support bracket.

16. The vehicle side window safety sun guard system of claim 15 wherein said visor comprises a sunlight blocking material that is opaque.

17. The vehicle side window safety sun guard system of claim 15 wherein said visor comprises a partial sunlight blocking material that is semi-transparent.

18. A vehicle side window safety sun guard system comprising:
a mounting flange;
a pivot arm comprising:
a pivot arm first portion having a proximate and a distal end;
a pivot arm second portion having a proximate and a distal end; and
a sunshield;
wherein said mounting flange is removably fastened above a vehicle driver's side door to an interior door framework;
wherein said mounting flange comprises a plurality of orifices for accepting fasteners such that said mounting flange is removably attached to said interior door framework above said vehicle driver's side door;
wherein said mounting flange comprises steel;
wherein said mounting flange is triangular or circular or comprises four perimeter edges;
wherein said pivot arm first portion comprises a 90 degree bend and wherein said distal end of said pivot arm first portion is coupled to said mounting flange such that said pivot arm first portion is horizontally rotatable;
wherein said pivot arm first portion comprises a greater than 90 degree bend;
wherein said pivot arm first portion comprises a less than 90 degree bend;
wherein said pivot arm first portion comprises a ferrous metal;
wherein said pivot arm second portion comprises a straight shaft having a proximate and a distal end and is coupled to said proximate end of said pivot arm first portion such that said pivot arm second portion is vertically rotatable;
wherein said vehicle side window safety sun guard system further comprising a pivot arm second portion support bracket for revolvably and rotationally coupling said proximate end of said pivot arm second portion;
wherein said pivot arm second portion comprises a ferrous metal;
wherein said visor comprises a cutout portion such that said proximate end of said pivot arm second portion is exposed for removably connecting to said pivot arm second portion support bracket;
wherein said pivot arm second portion vertical rotation movement is frictionally constricted within said pivot arm first portion such that said safety sun guard is able to remain in a user-preferred position for an extended duration;
wherein said sunshield is substantially flat having a first side and a second side and a proximate edge and a distal edge and wherein said distal edge has a greater thickness than said proximate edge and wherein said distal edge of said sunshield is non-removably attached to said pivot arm second portion such that said distal end of said sunshield envelopes said pivot arm second portion;
wherein said sunshield is telescopically functional;
wherein said sunshield comprises a visor that is movable and rotatably tiltable;
wherein said visor non-rotatably envelopes said pivot arm second portion;
wherein said visor is side positioned and located in said vehicle in addition to a front-mounted-visor;
wherein said visor comprises a sunlight blocking material that is opaque or semi-transparent; and
wherein said sunshield comprises a length sufficient to entirely shield a side window upper portion width such that said sunshield is useable as a sun-blocker to create greater visibility and safety for a user-driver when sunlight enters driver's said door side window of said vehicle, thereby relieving said user-driver from glare.

19. The vehicle side window safety sun guard system of claim 18 further comprising a kit having:
said sunshield with said pivot arm first portion and said pivot arm second portion, and said mounting flange;
said pivot arm second portion support bracket;
fasteners for said pivot arm second portion support bracket and said mounting flange; and
a set of user instructions.

20. A method of use for a vehicle side window safety sun guard system comprising the steps of:
gripping a proximate edge of a visor located above a side window on a vehicle;
adjusting said visor horizontally and/or vertically to a user preferred position for blocking sunlight from interfering with a driver-user's vision; and
returning said visor to a non-use condition adjacent to and above said side window.
